(19) United States
(12) Patent Application Publication
(10) Pub. No.: US 2022/0155494 A1
(43) Pub. Date: May 19, 2022

(54) THE MANUFACTURING METHOD OF HIGH-REFRACTIVE POLARIZED LENS

(71) Applicant: ONBITT CO., LTD., Hwaseong-si, Gyeonggi-do (KR)

(72) Inventors: Choong Deuk KIM, Suwon-si, Gyeonggi-do (KR); Soon Young KIM, Hwaseong-si, Gyeonggi-do (KR)

(73) Assignee: ONBITT CO., LTD., Hwaseong-si, Gyeonggi-do (KR)

(21) Appl. No.: 17/431,811

(22) PCT Filed: Mar. 2, 2020
(86) PCT No.: PCT/KR2020/002950

§ 371 Date: Aug. 18, 2021

(30) Foreign Application Priority Data
Mar. 12, 2019 (KR) 10-2019-0028244

(51) Int. Cl. G02B 3/00; G02B 5/30; G02B 1/04; B29D 11/00

(52) U.S. Cl. CPC G02B 3/0012; B29D 11/00201; G02B 1/041; G02B 5/3033

(57) ABSTRACT

Disclosed herein is a method for manufacturing a high-refractive polarized lens, the method comprises; pretreating both surfaces of the TAC film; preparing a pretreated polarized film by attaching the pretreated TAC film to both sides of a PVA film; forming the prepared pretreated polarized film into a lens shape; placing the formed pretreated polarized film on a mold for manufacturing a lens; injecting a polythiourethane-based resin into a lens manufacturing mold on which the pretreated polarized film is placed; and cooling the polythiourethane-based resin while the mold is fixed.

### BACKGROUND

### Technical Field

The present invention relates to a method for manufacturing a high-refractive polarized lens, and more particularly, to a method for manufacturing, which can secures the stability and reliability of a product by improving the adhesion of the polarized film to be attached to polythiourethane-based resin constituting a high-refractive polarized lens and preventing the polarized film from being detached from the urethane-based resin.

### Background Art

If human's eye receives the natural light which is reflected by natural objects and repeats reflection and refraction, glare occurs. In this case, the glare can be reduced by wearing polarized lens that applies the principle of polarization.

Polarization refers to a wave of light to vibrate in a specific direction by which natural light to be repeatedly reflected and refracted can be transmitted in only one direction through a polarized film (polarizer).

These polarized lenses can reduce glare by blocking reflected light and refracted light at sunrise or sunset, and lengthen the visible distance at which objects can be seen.

In addition, wearing polarized lenses while driving a car block unnecessary light, secure a wide of view, and help safe driving.

General polarized lenses is manufactured by a method which a polarized film (polarizer) is heated and attached to the surface of a plastic or glass lens, or which a polarized film is molded into a lens shape in advance, and then monomer or oligomer of liquid phase such as CR-39 (allyl diglycol carbonate) or urethane is casted on both sides of the polarized film, or which a polarized sheet which laminate a protective film such as a polycarbonate film on both sides of the polarizing film is molded into a lens shape, and then inserts the molded polarized sheet into an injection machine and reinforces thickness through injection.

In the case of high refractive polarized lenses (also called ‘MR lens’) to use polythiourethane, PVA (Poly Vinyl Acetate) films are attached to both sides of polythiourethane. There is a problem in that handling is difficult because the PVA film is thin and sensitive to moisture. To solve this problem, TAC (Tri Acetyl Cellulose) films were laminated on a PVA film, and the laminated film was attached to polythiourethane.

However, in the case of the film which TAC films are laminated on a PVA film, adhesion with a polythiourethane resin is lowered, so that the laminated film is easily detached from the lens during lens cutting processing finally.

### SUMMARY OF THE DISCLOSURE

The present invention has been made in an effort to solve the above-described problems associated with prior art. It is an object of the present invention to provide a method for manufacturing a high-refractive polarized lens to be able to secure the stability and reliability of a product by improving the adhesion of the polarized film to be attached to polythiourethane-based resin constituting a high-refractive polarized lens.

Moreover, it is another object of the present invention to provide a method for manufacturing a high-refractive polarized lens that the polarized film doesn't peel off even during cutting processing of a high-refractive polarized lens by improving the adhesion of the polarized film to a polythiourethane-based resin.

To achieve the above objects, there is provided a method for manufacturing a high-refractive polarized lens comprises; pretreating both surfaces of the TAC film; preparing a pretreated polarized film by attaching the pretreated TAC film to both sides of a PVA film; forming the prepared pretreated polarized film into a lens shape; placing the formed pretreated polarized film on a mold for manufacturing a lens; injecting a polythiourethane-based resin into a lens manufacturing mold on which the pretreated polarized film is placed; and cooling the polythiourethane-based resin while the mold is fixed.

In the present invention, the pretreatment of the TAC film is performed by which the TAC film is immersed in an aqueous NaOH solution so as to be surface-modified by the following chemical formula.

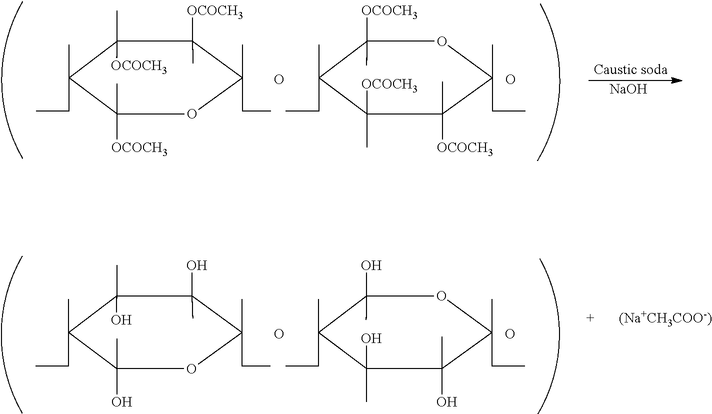

In the present invention, attaching the TAC film to the PVA film is accomplished by which an adhesive is applied on both sides of the PVA film and then the pretreated TAC film is attached on the PVA film.

In the present invention, the adhesive consists of a water-based adhesive formed by mixing PVA powder and water.

In the present invention, the polythiourethane resin is injected into the front and back surfaces of the pretreated polarized film.

In the present invention, the adhesion is increased by hydrogen bond between the pretreated polarized film and the polythiourethane resin.

### Advantageous Effects

The present invention can prevent the polarized film from detaching from the lens at the edge portion during the lens cutting processing by improving the adhesion between the lens of polythiourethane-based resin and the polarized film.

In addition, the present invention has an advantage that can manufacture thin and light lens and have the reliability for lens because of increasing the adhesion of the polarized film to the lens.

In addition, the present invention has the effect that can secure the reliability and stability of the product because the adhesion between the lens and the polarized film is excellent.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view showing the pretreatment of the TAC film according to the present invention.

FIG. 2 is a view showing the incidence angle of the pretreated TAC particles according to the present invention.

FIG. 3 is a cross-sectional view showing to attach the pretreated TAC film to the PVA film according to the present invention.

FIG. 4 is a cross-sectional view showing a state in which the polarized film is manufactured according to the present invention.

FIG. 5 is a cross-sectional view showing a state in which the polarized film is molded into a lens shape according to the present invention.

FIG. 6 is a cross-sectional view showing a state in which a polythiourethane-based resin is injected into a mold for manufacturing a lens according to the present invention.

FIG. 7 is a cross-sectional view in a state which the polarized lens is molded according to the present invention.

FIG. 8 is a flowchart illustrating a manufacturing process of a polarized lens according to the present invention.

FIG. 9 is a cross-sectional view showing a state in which a polythiourethane-based resin is injected into a mold for manufacturing a lens according to the present invention.

FIG. 10 is a cross-sectional view in a state in which the polarized lens is molded according to the mold of FIG. 9.

### MODES FOR CARRYING OUT THE INVENTION

The method of manufacturing a high refractive polarized lens according to the present invention will be described with reference to the accompanying drawings.

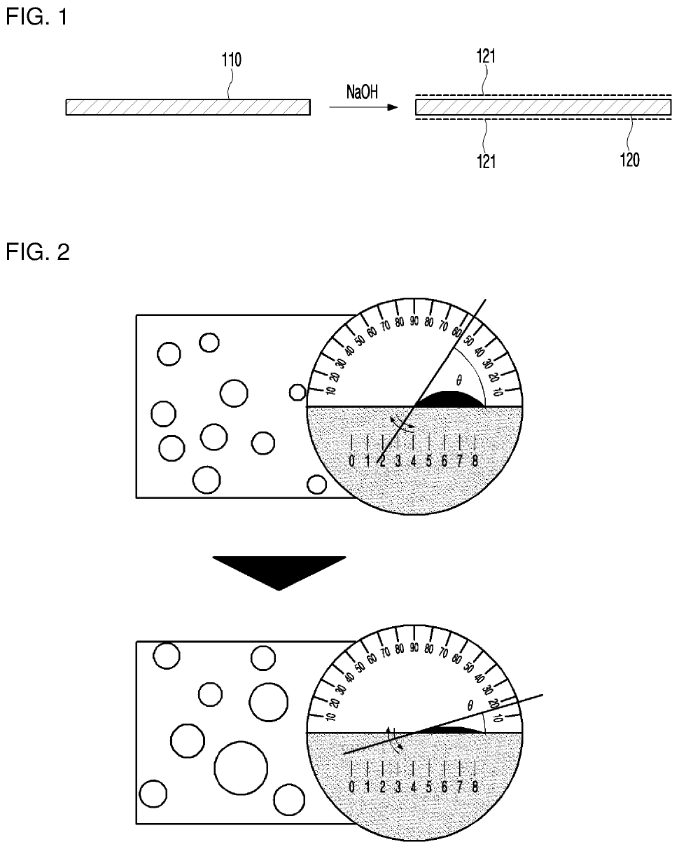

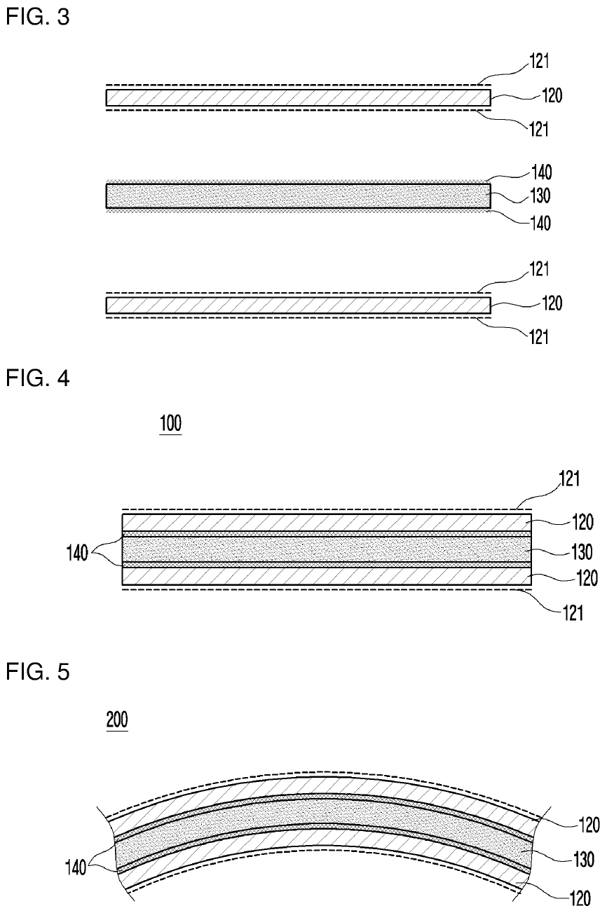

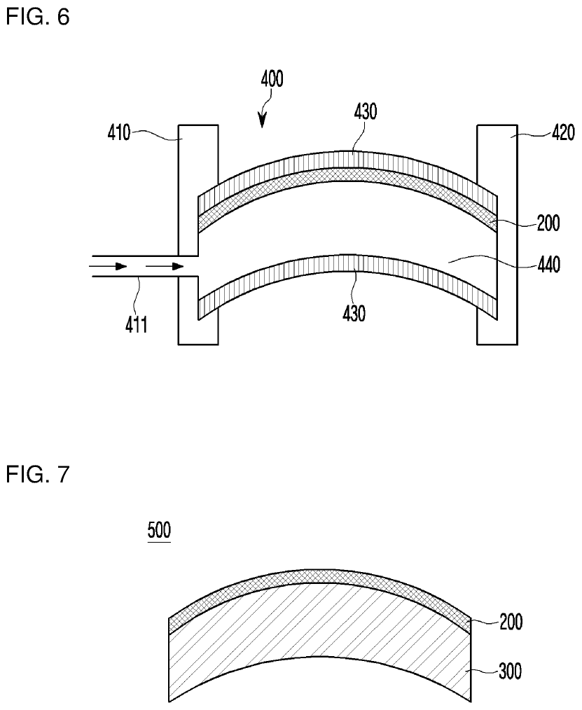

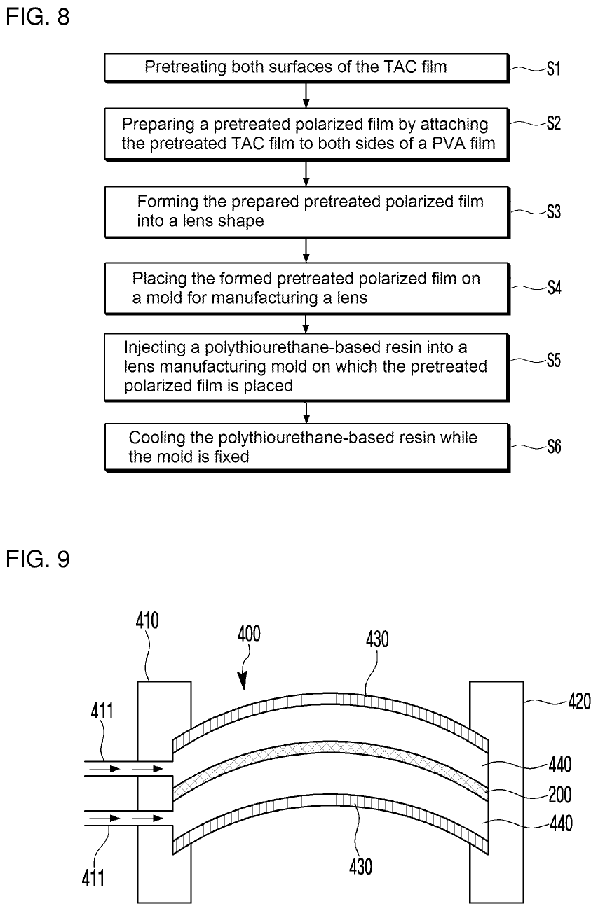

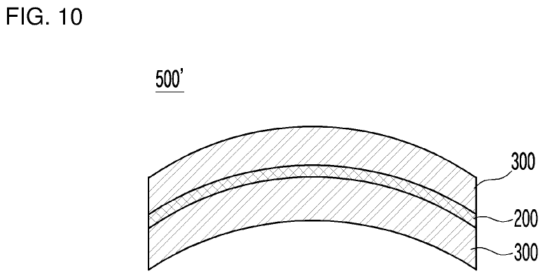

FIG. 1 is a cross-sectional view showing the pretreatment of the TAC film according to the present invention, and FIG. 2 is a view showing the incidence angle of the pretreated TAC particles according to the present invention, and FIG. 3 is a cross-sectional view showing to attach the pretreated TAC film to the PVA film according to the present invention, and FIG. 4 is a cross-sectional view showing a state in which the polarized film is manufactured according to the present invention, and FIG. 5 is a cross-sectional view showing a state in which the polarized film is molded into a lens shape according to the present invention, and FIG. 6 is a cross-sectional view showing a state in which a polythiourethane-based resin is injected into a mold for manufacturing a lens according to the present invention, and FIG. 7 is a cross-sectional view in a state which the polarized lens is molded according to the present invention, and FIG. 8 is a flowchart illustrating a manufacturing process of a polarized lens according to the present invention, and FIG. 9 is a cross-sectional view showing a state in which a polythiourethane-based resin is injected into a mold for manufacturing a lens according to the present invention, and FIG. 10 is a cross-sectional view in a state in which the polarized lens is molded according to the mold of FIG. 9.

The manufacturing process of the polarized lens is described in detail with reference to FIG. 8. At first, pretreating both sides of a triacetyl cellulose (TAC) film of about 0.1 mm is performed (S1). The reason for the pretreatment of the TAC film 110 is to allow the TAC film 110 to adhere well to a polythiourethane (also referred to as an MR lens)-based resin for making a high refractive lens. In the pretreatment of the TAC film 110, the surface of the TAC film 110 is modified by immersing the TAC film 110 in an aqueous NaOH solution. Chemical formula 1 according to the modifing reaction is as follows.

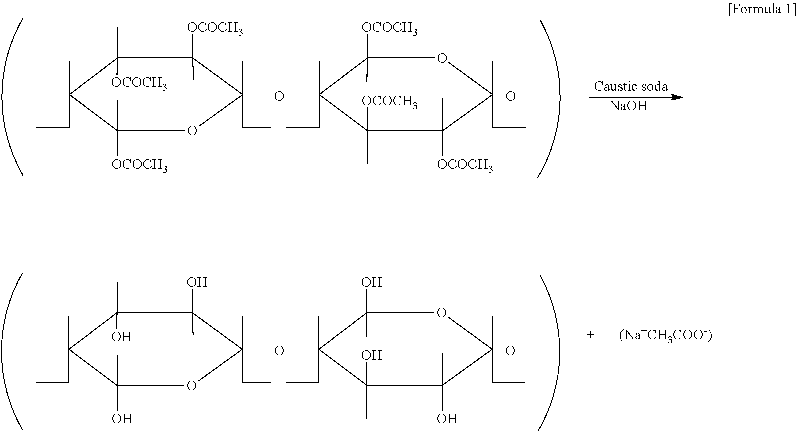

As shown in Chemistry 1, a hydroxyl group (OH⁻) is formed on the surface of the TAC film after the surface modification reaction. Since the hydroxyl group formed on the surface of the TAC film bonds with the polythiourethane, it is possible to prevent the TAC film from being detached from the polythiourethane resin. For this reason, a process of modifying the surface of the TAC film is performed. FIG. 2 is a view showing the angle of incidence of pretreated TAC particles compared before and after pretreatment. As shown in the figure, the difference between the angles of incidence before and after the pretreatment is large, and since the angle of incidence of the pretreated TAC particles is small, the contactable surface area can be widened, so that it is easy to contact and bond with other materials.

Next, the pretreated TAC film 120 is adhered to both sides of a polyvinyl acetate (PVA) film 130 having a thickness of about 0.03 to 0.05 mm using a water-based adhesive 140 to form a polarized film 100 (S2). The manufacturing process is shown in FIG. 3, and the manufactured polarized film 100 is shown in FIG. 4. As shown on FIG. 3, the TAC film 120 is attached to the both surfaces of PVA film 130 after applying the water-based adhesive 140 to the surfaces of PVA film 130. The water-based adhesive 140 can be prepared by mixing PVA powder and water. The PVA film 130 can use a resin film such as polyvinyl alcohol-based resin which is uniaxially stretched or uniaxially stretched after stabilizing a resin film with a formate, and the PVA film 130 can be doped with iodine or a dichroic dye to increase the degree of polarization.

Next, the polarized film 100 is molded into a lens shape as shown in FIG. 5 (S3).

Next, the polarized film 200 molded into a lens shape is inserted and fixed inside the lens manufacturing mold 400 (S4).

As shown in FIG. 6, the lens manufacturing mold 400 has rubber packings 410 and 420 on both sides, and an injection hole 411 is formed on the rubber packing 410 through which polythiourethane is injected. A lens-shaped blocking plate 430 is provided at the upper and lower portions between the rubber packing 410 and the rubber packing 420. The blocking films 430 may be made of a material such as glass. The polarized film 200 is positioned between the blocking plates 430, and an injection space 440 is formed between each blocking plate 430 and the polarized film 200.

After inserting and fixing the polarized film 200 in the mold 400 for manufacturing the lens, polythiourethane resin 300 is injected through the injection hole 411 provided on one side of the mold 400, and the polythiourethane resin 300 is mixed and injected with thermosetting agent into the injection space 440 formed in the lower part of the polarized film 200.

After the polythiourethane resin 300 is charged in the lower part of the polarized film 200, the polythiourethane resin 300 and the polarized film 200 are attached by cooling for a certain period of time, and when cooling is completed, the manufacture of the polarized lens 500 is completed (S6).

Polythiourethane resin 300 is used to manufacture high refractive lenses, and in particular, MR™ lenses (registered trademarks of Mitsui Chemicals Co., Ltd.) are a kind of lenses using polythiourethane, and the products are being released in series of high refractive lenses. Looking at the MR lens series, MR-8 has a refractive index of 1.60, MR-7 and MR-10 have a refractive index of 1.67, and MR-174 has a refractive index of 1.74, which is suitable for manufacturing thin lenses as the refractive index increases. Chemical formula of a general polythiourethane resin 300 is as follows.

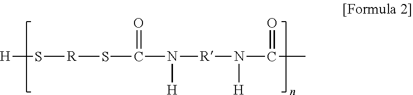

As shown in Chemical Formula 2, the hydroxyl group (OH) of the TAC film of Chemical Formula 1 is hydrogen-bonded with SH, which is the terminal end of the polythiourethane resin 300 of Chemical Formula 2, and the TAC film can be strongly attached to the polythiurethane resin 300 by hydrogen bond with polythiourethane. Accordingly, the adhesion of the TAC film to the polythiourethane resin may be strong.

FIG. 9 and FIG. 10 show that the polythiourethane resin 300 is attached to the upper and lower surfaces of the polarized film 200 in the lens manufacturing mold. The polythiourethane resin 300 is injected into the upper and lower surfaces of the pretreated polarized film 200, and the hydroxyl groups (OH) of the surfaces of the TAC films to be attached to the pretreated polarized film 200 are formed of the (300).) is hydrogen-bonded with the distal end (SH) of the polythiourethane resin 300 of Formula 2, and the polythiourethane resin 300 and the TAC film can be strongly attached by hydrogen bond.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A method for manufacturing a high-refractive polarized lens comprises;
pretreating both surfaces of the TAC film;
preparing a pretreated polarized film by attaching the pretreated TAC film to both sides of a PVA film;
forming the prepared pretreated polarized film into a lens shape;
placing the formed pretreated polarized film on a mold for manufacturing a lens;
injecting a polythiourethane-based resin into a lens manufacturing mold on which the pretreated polarized film is placed; and
cooling the polythiourethane-based resin while the mold is fixed.

2. The method of claim 1, wherein the pretreatment of the TAC film is performed by which the TAC film is immersed in an aqueous NaOH solution so as to be surface-modified by the following chemical formula.

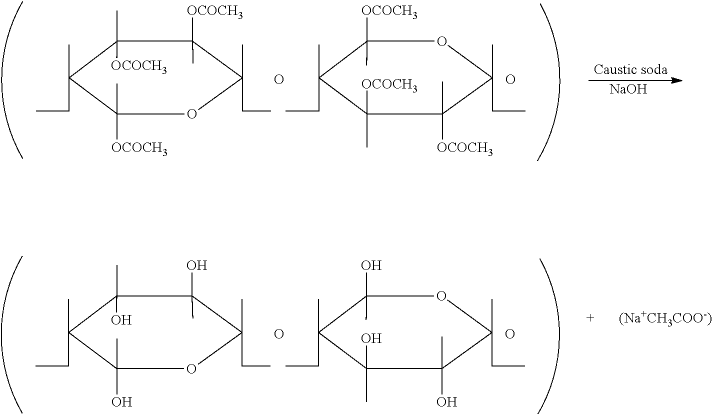

3. The method of claim 1, wherein attaching the TAC film to the PVA film is accomplished by which an adhesive is applied on both sides of the PVA film and then the pretreated TAC film is attached on the PVA film.

4. The method of claim 3, wherein the adhesive consists of a water-based adhesive formed by mixing PVA powder and water.

5. The method of claim 1, wherein the polythiourethane resin is injected into the front and back surfaces of the pretreated polarized film.

6. The method of claim 5, wherein the adhesion is increased by hydrogen bond between the pretreated polarized film and the polythiourethane resin.
